(19) United States
(12) Patent Application Publication
(10) Pub. No.: US 2018/0111360 A1
(43) Pub. Date: Apr. 26, 2018

(54) PVC COMPOSITE FLOORING

(71) Applicant: Wenhui XIAO, Yinkou City (CN)

(72) Inventors: Wenhui Xiao, Yinkou City (CN); Wenqun Xiao, Yinkou City (CN)

(73) Assignee: Wenhui XIAO, Yinkou City (CN)

(21) Appl. No.: 15/404,592

(22) Filed: Jan. 12, 2017

(30) Foreign Application Priority Data
Oct. 21, 2016 (CN) 201610920219.2

(51) Int. Cl. B32B 29/00; B32B 5/20; B32B 7/12; B32B 37/12; E04F 15/10

(52) U.S. Cl. CPC B32B 29/007; B32B 2451/00; B32B 7/12; B32B 37/1207; E04F 15/105; B32B 2255/12; B32B 2255/20; B32B 2260/028; B32B 2260/046; B32B 2266/0235; B32B 2037/1215; B32B 2305/022; B32B 2262/067; B32B 2307/554; B32B 2309/022; B32B 2327/06; B32B 2317/122; B32B 2471/00; B32B 5/20

(57) ABSTRACT

The invention relates to a PVC composite flooring, comprising PVC base material and decorative board with alumina hot-pressed on the surface. The invention also relates to a process of preparation for the PVC composite flooring, comprising bonding the PVC base material and the decorative board with alumina hot-pressed on the surface using a hot-melt adhesive. The PVC composite flooring of the present invention is excellent in abrasion resistance, has remarkably improved resistance to indentation, is particularly excellent in compression stability.

### FIELD OF THE INVENTION

The invention relates to the field of flooring, more particularly to composite PVC flooring with alumina hot-pressed on the surface.

### BACKGROUND OF THE INVENTION

PVC flooring refers to flooring produced using PVC material, and is a very widely used new light-weight ground decoration material in the world, also known as “light-weight flooring”; it is a very popular product in Europe and America, as well as in Japan and Korea in Asia. Since 1980's, PVC flooring has entered Chinese market and has already been well recognized in large and medium domestic cities; it has wide applications in, for example, home, hospital, school, office building, factories, public places, supermarket, commercial places, etc. However, PVC flooring has low abrasion resistance, prone to scratches, and difficult to clean. In addition, surface textures of current PVC flooring are patterns obtained by using different colored particles, based on the differential flow rates of materials; the patterns are therefore relatively simple and not vivid.

Wood flooring can be mainly classified into two categories, i.e., solid wood flooring and laminate flooring. Since the solid wood flooring has disadvantages of poor stability, high cost, difficult maintenance, and limited availability of wood, laminate flooring is more widely used. Base materials of the laminate flooring are typically medium-density or high-density fiberboard and particleboard. Laminate flooring has good dimensional stability; the surface layer is impregnated decorative paper containing wear-resistant materials, which ensures that the surface layer has good wear resistance, burning resistance, scratch resistance and resistance to pollution. However, the main problem of laminate flooring is its high content of formaldehyde, thus, laminate flooring is also known as the “toxic floor.” Both wood floorings are not waterproof, neither fire-proof.

Thus, it is desirable to have a new flooring as a replacement of current PVC flooring, which has not only the advantages of PVC flooring, but also the abrasion resistance and beautiful appearance of laminate flooring.

### SUMMARY OF THE INVENTION

In one aspect, the invention provides a PVC composite flooring, comprising:
PVC base material; and
decorative board with alumina hot-pressed on the surface.

Preferably, the PVC base material and the decorative board with alumina hot-pressed on the surface are bonded using moisture-curing reactive polyurethane hot-melt adhesive.

In another aspect, the invention provides a process of production for PVC composite flooring, including the following steps:

1) The following components in parts by weight are mixed homogenously in a mixing equipment, the temperature is controlled at 100-110° C., mixing time is 3-8 min; the mixture is then introduced into a cold mixing pan and continuously stirred, the material is cooled to 35-40° C., and the time is controlled within the range of 5-10 min:

Resin: 100

Filler: 10-350

Stabilizer: 8-20

Lubricant: 8-20

The resulting material is then fed into an extruder and is extruded to provide PVC base material, wherein, the barrel temperature of the extruder is 140-210° C., which has a saddle-type temperature setting from high to low and back to high;

2) Base paper is formed from one or more pieces of Kraft paper, which are impregnated with adhesives and stacked together, followed by adhesive spraying and cold forming,

The decorative paper is then immersed in melamine resin adhesive, dried, and arranged on the base paper; the resulting material is treated at 140-160° C. under a continuous pressure of 90-110 kg/cm² for 1-1.5 h to form the decorative board;

Abrasion-resistant alumina paper is then hot-pressed on the surface of the decorative board at 170-230° C. and under a pressure of 2000-2600 tons to form the decorative board with alumina hot-pressed thereon;

3) the PVC base material obtained in step 1) and the decorative board with alumina hot-pressed thereon obtained in step 2) are bonded together using an adhesive to provide PVC composite flooring.

The PVC composite flooring of the invention has not only wood grain texture of the solid wood flooring, but also abrasion resistance of the laminate flooring; meanwhile, it has features such as waterproof, fire-proof, corrosion resistance, wear resistance, staying warm, energy saving, and environmentally friendly. Therefore, its comprehensive cost effectiveness is particularly high.

In addition, the PVC flooring of the invention is produced through a new process, which, when compared to conventional processes, has advantages of saving time and cost.

### DETAILED DESCRIPTION OF THE INVENTION

Unless defined otherwise, all technical and scientific terms used herein have the same meaning as commonly understood by one of ordinary skilled in the art to which this invention belongs. In the case of conflict, the definitions in this specification shall prevail.

Unless otherwise indicated, all percentages, parts, ratios, and the like are by weight.

When a value or numerical range, a preferred range, or a series of lower and upper preferred values are given, it is to be understood that it specifically discloses all ranges between any pair of values from any lower limiting values and preferred values and any larger limiting values or preferred values, regardless of whether or not the ranges are disclosed separately. Unless otherwise indicated, for numerical ranges stated herein, the numerical ranges are intended to include all integrals and fractions within the range end-values and ranges.

When the term “about” is used to describe a numerical value or an end value of a numerical range, the disclosure is to be understood to include that particular numerical value or the associated end value.

“a” and “an” are used to describe elements and components of the present invention. This is only for convenience and to provide a general description of the invention. Unless otherwise indicated, the description is to be understood as including one or more or at least one species.

The PVC base material used in the present invention is a sheet produced by adding a filler, a plasticizer, a stabilizer, a colorant and the like to a polyvinyl chloride resin as a main raw material through a calendering, extrusion or compression process.

In a preferred embodiment of the present invention, the PVC base material comprises the following components (in parts by weight):

PVC resin: 100

Filler: 10-350

Stabilizer: 8-20

Lubricant: 8-20

In the present invention, the PVC resin may be selected from type 5, type 7 and type 8 PVC resins or combinations thereof. According to China's requirements on PVC resin model, type 5 PVC resin refers to those with a K value of 68-66 and a degree of polymerization of 1100-1000; type 7 PVC resin refers to those with a K value of 62-60 and a degree of polymerization of 850-750; type 8 PVC resin refers to those with a K value of 59-55 and a degree of polymerization of 750-650.

The filler may be selected from fillers commonly used in the field of PVC flooring, such as one or more selected from hard calcium carbonate, light calcium carbonate, activated calcium carbonate, kaolin, talc, montmorillonite and the like.

The stabilizer and the lubricant may be selected from those ingredients commonly used in the field of PVC flooring, such as stearate, oxidized polyethylene wax, and the like.

In one preferred embodiment, the PVC base material preferably comprises the following components (in parts by weight):

Blowing agent: 0.1-10

Foam control agent: 0.3-30

Wherein, the blowing agent and the foam control agent may be selected from ingredients conventionally used in the field of PVC flooring, such as commercially available azodicarbonamide blowing agent and the like.

In another preferred embodiment, the PVC base material further comprises the following components (in parts by weight):

Wood fiber: 0.5-5

In the PVC base material of the present invention, according to different application requirements, various additives may be added to improve the adaptability of the products. For example, impact modifiers can be added to improve the impact resistance, toughening agents can be added to improve the toughness of PVC products at low temperatures, and antioxidants can be added to improve the weather resistance and so on.

In one preferred embodiment, the decorative board comprises base paper and decorative paper.

The base paper can be obtained by the following process. One or more pieces of Kraft paper are impregnated with adhesives and stacked together, uniformity of the amount of adhesives is ensured and the thickness is controlled. The resulting material is then subject to adhesive spraying and cold forming to form the base paper. During the process, base paper is prepared using Kraft paper instead of solid wood surface layer because the cost of the solid wood surface layer is higher and also its wettability is lower than that of Kraft paper and is thus not suitable for adhesive impregnation.

The decorative board can be obtained by the following process, decorative papers having different colors or textures are immersed in a melamine resin adhesive, dried to a certain degree of curing, and arranged on the base papers, the resulting material is then subject to high temperature of about 150° C. and a constant uniform pressure of about 100 kg/cm² for about 1 hour to form the decorative board.

Subsequently, in order to improve the abrasion resistance of the decorative board, abrasion resistant alumina paper is hot pressed on the surface of the decorative board at a temperature of 170-230° C. and a pressure of 2000-2600 tons, and the higher the mass of the alumina hot-pressed, the higher the abrasion resistance imparted to the decorative paper.

Finally, the resulting decorative board with alumina hot-pressed thereon is subject to trimming and scrubbing operations by conventional processes.

The inventors of the present invention have noted that it is only by hot-pressing alumina on the decorative board through the above-described process that the alumina can be completely dissociated while maintaining the abrasion resistance of the alumina, which enables the abrasion resistant alumina layer to be transparent and clearly shows the texture and color of the underlying decorative paper. If the alumina is simply adhered to the decorative paper by an adhesive, the alumina on the surface of the formed decorative board cannot dissociate, as a result, the surface is opaque, and the desired texture and color of the flooring cannot be clearly shown.

The PVC base material prepared and the decorative board with alumina hot-pressed thereon are bonded together using an adhesive. The two are preferably bonded by using moisture-curing hot-melt adhesives, where the moisture curing means that the hot-melt adhesive reacts with moisture in the air to become a solid when in contact with air.

The moisture-curing hot-melt adhesives used in the present invention are preferably moisture-curing reactive polyurethane hot-melt adhesives, which are commercially available. The moisture-curing reactive polyurethane hot-melt adhesive has better tackifying effect than other resin adhesives, particularly, it is even more so for base materials such as paper, cloth, wood, and the like.

Conventionally used adhesives in the laminate flooring industry are typically cold adhesives, i.e., adhesives that do not require heating prior to bonding, and include primarily one or two component cold adhesives, such as polyurethane adhesives and acrylic adhesives. Cold adhesives need to be continuously pressed with a press until the adhesives are cured. The curing reaction of the two-component cold adhesives take place once the two components the main agent and the curing agent are mixed, the effective application window is short, waste tends to be resulted, therefore not suitable for automated production. Also, after the base material and the decorative board are bonded by the cold adhesives, there is still a need to apply a pressure of 15 MPa per square centimeter for about 120 min for curing, which increases production time and costs.

Furthermore, when adhesives such as acrylate adhesives are used in the field of conventional laminate flooring, it is also necessary to heat the material after the workpieces have been pressed for a certain period of time by using a press so as to completely cure the adhesives, and thus to obtain the desired strength of the final flooring. However, in terms of PVC flooring, because of the characteristics of PVC itself, PVC base material softens and deforms at temperatures higher than 70° C. Therefore, the use of traditional adhesives such as acrylate adhesives faces the dilemma of increasing the heating temperature to maintain bond strength and decreasing the heating temperature to maintain the performance of the PVC base material.

To overcome the above-mentioned drawbacks of the conventional adhesives, the inventors of the present invention have carried out a series of scientific experiments and have chosen moisture-curing reactive polyurethane hot-melt adhesives as the adhesive.

The moisture-curing reactive polyurethane hot-melt adhesive, which is a high performance environmentally friendly adhesive, contain no water or solvent and has a solid content of 100%. In comparison with traditional acrylate adhesives, it does not require application of pressure in the production process of flooring, as well as the high temperature curing process after press. Meanwhile, it has characteristics of conventional hot-melt adhesives, such as containing no solvent, high initial viscosity, fast positioning while assembly, and the like. Its adhesive application temperature is lower than ordinary hot-melt adhesive; while having the rapid bonding performance of hot-melt adhesives, it reacts with moisture in the air and finally results in formation of polyurethane resin with high strength, high flexibility, waterproof, temperature resistance.

In addition, the polyurethane hot-melt adhesive is resistant to water immersion, and is resistant to erosion from most solvents and oil. The reactive polyurethane hot-melt adhesive has low adhesive application temperature; therefore it is possible to effectively prevent the deformation of the base material due to the high temperature.

The polyurethane hot-melt adhesive is 100% solids and does not contain any volatile organic components (VOC), and does not require any drying equipment. This avoids the environmental problems associated with solvent-borne products and the energy issues associated with drying solvent-based products and water-based products. Because it does not contain any solvents, there is no release of any harmful ingredients during the curing process and after the curing, meeting fully the health and safety requirements at home. The invention uses a moisture-curing reactive polyurethane hot-melt adhesive which, upon completion of the application, reacts with moisture in the air or in the base material to form polyurethane that cannot be re-melted by reheating. As a result, this mitigates the time-consuming problem of using an acrylate adhesive and saves cost by the fact that no press under pressure is required.

According to the present invention, commercially available moisture-curing reactive polyurethane hot-melt adhesives can be used. In the examples of the present invention, Nanbao Resin K-AA20 moisture-curing reactive polyurethane hot-melt adhesive produced by Taiwan Nanbao Resin Group is preferably used.

In one embodiment of the present invention, the moisture-curing reactive hot melt adhesive was first heated and melted, and then coated on the surface of the PVC base material, the decorative board was placed on top of the surface of the hot-melt adhesive to provide the final product—PVC composite flooring of the present invention. It should be noted that, during the bonding process, it is not necessary to press the workpieces for a certain period of time by using a press, nor it is needed to further heat the material after the bonding of the base material and the decorative board.

Now, the invention will be further illustrated by reference to the following examples in a non-limiting manner.

### EXAMPLES

PVC composite floorings according to the invention were prepared and further compared with a PVC composite flooring according to the prior art.

### Materials Used:

Flooring 1: PVC composite flooring according to the present invention, wherein moisture-curing reactive hot-melt adhesive was used as the adhesive;

Flooring 2: PVC composite flooring according to the present invention, wherein cold adhesive was used as the adhesive;

Flooring 3: prior art PVC flooring, which is produced by calendaring or extrusion or compression processes, its abrasion-resistant surface layer is PVC material.

Cold adhesive: polyurethane adhesive, a two components adhesive, manufactured by Dongguan Lanbao new material Co. Ltd.

Moisture-curing reactive hot-melt adhesive: Nanbao Resin K-AA208 manufactured by Taiwan Nanbao Resin Group.

### Process of Preparation for the Flooring of the Present Invention

Preparation of flooring 1—PVC composite flooring of the present invention

1). First, PVC Base Material was Prepared According the Following Formula

### (In Parts of Weight).

| | formula |
|---|---|
| PVC resin | 100 |
| Filler (1:1:1 of hard calcium carbonate, light calcium | 180 |
| carbonate and activated calcium carbonate) | |
| Stabilizer (stearate) | 14 |
| Lubricant (oxidized polyethylene wax) | 14 |
| Blowing agent (Azodicarbonamide) | 5 |
| Foam control agent | 15 |
| Wood fiber | 3 |

The materials of the above formula were thoroughly admixed in a mixing equipment, the temperature was controlled at about 105° C., the higher the resin content, the lower the temperature required; the mixing time was 3-8 min, which was set according to the composition of the product. The resulting mixture was then introduced into a cold mixing pan and continuously stirred, so that the material was cooled to 35-40° C.; the time was controlled at 5-10 min.

The resulting material is then fed into an extruder to provide PVC base material, wherein, the barrel temperature of the extruder is 140-210° C., which has a saddle-type temperature setting from high to low and back to high; the higher the resin content, the lower the temperature required, and the lower the temperature, the higher the rate.

2). Preparation of Decorative Paper with Alumina Hot-Pressed Thereon

One or more pieces of Kraft paper was impregnated with adhesives and stacked together, uniformity of the amount of adhesives was ensured and the thickness was controlled. The resulting material was then subject to adhesive spraying and cold forming to form the base paper.

After the preparation of the base paper, decorative papers having different colors or textures were immersed in a melamine resin adhesive, dried to a certain degree of curing, and arranged on the base papers, the resulting material is then subject to high temperature of about 150° C. and a constant uniform pressure of about 100 kg/cm² for about 1 hour to form the decorative board.

Subsequently, abrasion resistant alumina paper was hot pressed on the surface of the decorative board at a temperature of 170-230° C. and a pressure of 2000-2600 tons, the higher the mass of the alumina hot-pressed, the higher the abrasion resistance imparted to the decorative board.

Finally, the resulting decorative board with alumina hot-pressed thereon is subject to trimming and scrubbing operations by conventional processes.

3). The Three PVC Base Materials and the Decorative Paper with Alumina Hot-Pressed Thereon Obtained Above were Bonded Using Moisture-Curing Reactive Polyurethane Hot-Melt Adhesive to Provide the PVC Composite Flooring of the Invention.

Specifically, the moisture-curing reactive polyurethane hot-melt adhesive of the present invention was platen bonded by the following process: the heating member is an aluminum alloy heating plate; while application, the heating plate was pressed from top downward into an adhesive-containing tub, the heating plate was positioned above the hot-melt adhesive; when the heating plate was heating, the temperature was between 110° C. and 130° C.; only the top layer of the adhesive was in contact with the heating plate, so that it reached the melting point and became melted; the lower part of the adhesive-containing tub was not heated at the time, only the amount needed for the production was melted, so as to avoid aging and deterioration of the hot-melt adhesive due to prolonged heating. During the melting, the hot-melt adhesive was separated from the air: an O-ring seal arranged between the heating plate and the inner wall of the adhesive-containing tub prevented the contact between the molten liquid adhesive and the air, ensuring the application conditions required for the moisture-curing reactive polyurethane hot-melt adhesive. The plate was made of aluminum alloy, precision machined using CNC, the outer surface of the heating plate was treated by DuPont's Teflon through deep penetration and sintering, which has high coating strength and difficult to fall off. Hot-melt adhesives thereon can be very easily removed, which can effectively prevent the carbonization of the hot-melt adhesive and reduce the blockage of the adhesive transferring system.

Upon continuous operation of the dispenser, the molten moisture-curing reactive polyurethane hot-melt adhesive was evenly coated on the surface of the PVC base material, which was then quickly bonded to the decorative board, the bonding was instant, no additional pressure is needed for firm bonding.

Preparation of flooring 2: the process was the same to that for the preparation of flooring 1, except that cold adhesive was used in step 3) to replace the moisture-curing reactive hot-melt.

### Example 1

### Testing the Surface Abrasion Resistance of Flooring 1

A piece of the PVC composite flooring of the present invention (flooring 1) was tested for abrasion resistance according to EN 660-2: 1999+A1: 2003 AND EN 649: 2011, wherein, each abrasion wheel had a load of (1±0.01) kg, the sand-dropping rate was (21±3) g/min.

Test results: The wear value is less than 0.1 g per 100 revolutions, and the abrasion resistant layer is not obviously damaged at 6000 rpm.

### Example 2

### Testing the Resistance to Indentation of Flooring 1

According to EN ISO 24343-1: 2012, the test sample was placed on a flat surface, and a toroidal loaded weight was placed on the test sample. A total of 500 N force was slowly applied to the sample surface within 2S. After 150 min, the applied force was removed, and after another 150 min, the final thickness of the sample was measured using an appropriate instrument to an accuracy of 0.01 mm.

Test results: after the test described above, it was measured that the thickness of the PVC composite flooring of the invention decreased by 0.01 mm.

### Example 3

### Testing the Stability of the Flooring 1

According to EN ISO 23999: 2012, the warp height and the sizes of the sample were first measured, and then the sample was placed in an oven at (80±2) ° C., after (360±15) min, the sample was placed at (23±2) ° C. and a relative humidity of (50±5)% for at least 24 h, the warpage height and the sizes of the sample were recorded and the amount of change was calculated.

Test results: The PVC composite flooring of the invention had a dimensional change ratio of 3%

### Example 4

### Testing the Flame Retardancy of the Flooring 1

The flame retardancy of flooring 1 was tested according to ASTM E84-12A.

Test results: flame spread index FSI was <10, smoke development index SDI was <100.

### Example 5

### Testing the Bonding Performance of the Flooring 1

The flooring 1 was tested for its internal bond strength as the representative bonding performance according to GB/T18102-2000.

Test results: the average value of the internal bond strength of the PVC composite flooring of the invention using the moisture-curing reactive polyurethane hot-melt adhesive was 1.20.

### Example 6

### Testing the Bonding Performance of the Flooring 2

The flooring 2 was tested for its internal bond strength as the representative bonding performance according to GB/T18102-2000.

Test results: the internal bond strength of the PVC composite flooring of the invention using the cold adhesive was 1.05.

### Example 7

### Testing the 180 Degree Peeling Strength of the Flooring 1

The flooring 1 was tested for its peeling strength as the characteristic bonding performance according to ISO 8510-2: 1990.

Test results: The peel strength of the PVC composite flooring of the invention using the moisture-curing reactive polyurethane hot-melt adhesive was 4.64 kN/m⁻¹.

### Example 8

### Testing the Peeling Strength of the Flooring 2

The flooring 2 was tested for its peeling strength as the characteristic bonding performance according to ISO 8510-2: 1990.

Test results: The peel strength of the PVC composite flooring of the invention using the cold adhesive was 1.54 kN/m⁻¹.

### Comparative Example 1

### Testing the Abrasion Resistance of the Flooring 3

Three pieces of the same prior art PVC flooring were used for the test.

The first sample was worn out before completing 5000 revolutions; the sample was discarded.

While testing the remaining two samples, stop at every 200 revolutions for observation until 2000 revolutions or the sample was worn out.

Test results: for the prior art PVC flooring, The wear value was higher than 0.15 g per 100 revolutions.

### Comparative Example 2

### Testing the Resistance to Indentation of the Flooring 3

The test process of example 2 was repeated, except that the prior art PVC flooring was used as the test sample.

Test results: the thickness of the prior art PVC flooring decreased by 0.1 mm.

### Comparative Example 3

### Testing the Stability of the Flooring 3

The test process of example 3 was repeated, except that the prior art PVC flooring was used as the test sample.

Test results: the prior art PVC flooring had a dimensional change ratio of 15%

From the above examples and comparative examples, it can be found that the PVC composite flooring of the present invention is excellent in abrasion resistance, has remarkably improved resistance to indentation, is particularly excellent in compression stability, and has high flooring bonding strength.

While the invention has been specifically described by way of embodiments and examples, these embodiments and examples are not to be construed as limiting the scope of the invention. It should be understood by those skilled in the art that various modifications and variations of the PVC composite flooring can be made on the basis of the present disclosure, such modifications and variations are intended to be included within the spirit of the invention.

1. A PVC composite flooring, comprising:
PVC base material; and
decorative board with alumina hot-pressed on the surface.

2. The PVC composite flooring according to claim 1, wherein the PVC base material and the decorative board with alumina hot-pressed on the surface are bonded using moisture-curing reactive polyurethane hot-melt adhesive.

3. The PVC composite flooring according to claim 1, wherein the PVC base material comprise in parts by weight the following components:
Resin: 100
Filler: 10-350
Stabilizer: 8-20
Lubricant: 8-20

4. The PVC composite flooring according to claim 3, wherein the PVC base material further comprises in parts by weight the following components:
Blowing agent; 0.1-10
Foam control agent: 0.3-30

5. The PVC composite flooring according to claim 4, wherein the PVC base material comprises in parts by weight the following component:
Wood fiber: 0.5-5

6. The PVC composite flooring according to claim 1, wherein the decorative board comprises the base paper and the decorative paper, the base paper was formed by adhesive spraying and cold forming of one or more layers of Kraft paper impregnated with adhesive.

7. The PVC composite flooring according to claim 1, wherein the decorative board with alumina hot-pressed on the surface was prepared by the following process: alumina was hot-pressed on the surface of the decorative board at 170-230° C. and a pressure of 100-2600 tons.

8. The PVC composite flooring according to claim 1, wherein the number of revolutions in the abrasion resistance test according to EN 660-2:1999+A1:2003 AND EN 649:2011 was at least 6000 revolutions.

9. Process of preparation of PVC composite flooring, comprising the following steps:
1) The following materials in parts by weight were thoroughly admixed in a mixing equipment, the temperature was controlled at 100-110° C., the mixing time was 3-8 min. The resulting mixture was then introduced into a cold mixing pan and continuously stirred, so that the material was cooled to 35-40° C., the time was controlled at 5-10 min:
Resin: 100
Filler: 10-350
Stabilizer: 8-20
Lubricant: 8-20
The resulting material is then fed into an extruder to provide the PVC base material, wherein, the barrel temperature of the extruder is 140-210° C., which has a saddle-type temperature setting from high to low and back to high;
2) One or more pieces of Kraft paper were impregnated with adhesives and stacked together, the resulting perform was subject to adhesive spraying and cold forming to form the base paper,
The decorative paper is then immersed in melamine resin adhesive, dried, and arranged on the base paper; the resulting material is treated at 140-160° C. under a continuous pressure of 90-110 kg/cm² for 1-1.5 h to form the decorative board;
Abrasion-resistant alumina paper is then hot-pressed on the surface of the decorative board at 170-230° C. and under a pressure of 2000-2600 tons to form the decorative board with alumina hot-pressed thereon; and
3) the PVC base material obtained in step 1) and the decorative board with alumina hot-pressed thereon obtained in step 2) are bonded together using an adhesive to provide PVC composite flooring.

10. The process of preparation of the PVC composite flooring according to claim 9, wherein the adhesive used in step 3) is a moisture-curing reactive polyurethane hot-melt adhesive.

11. The PVC composite flooring according to claim 2, wherein the decorative board comprises the base paper and the decorative paper, the base paper was formed by adhesive spraying and cold forming of one or more layers of Kraft paper impregnated with adhesive.

12. The PVC composite flooring according to claim 3, wherein the decorative board comprises the base paper and the decorative paper, the base paper was formed by adhesive spraying and cold forming of one or more layers of Kraft paper impregnated with adhesive.

13. The PVC composite flooring according to claim 4, wherein the decorative board comprises the base paper and the decorative paper, the base paper was formed by adhesive spraying and cold forming of one or more layers of Kraft paper impregnated with adhesive.

14. The PVC composite flooring according to claim 5, wherein the decorative board comprises the base paper and the decorative paper, the base paper was formed by adhesive spraying and cold forming of one or more layers of Kraft paper impregnated with adhesive.

15. The PVC composite flooring according to claim 2, wherein the decorative board with alumina hot-pressed on the surface was prepared by the following process: alumina was hot-pressed on the surface of the decorative board at 170-230° C. and a pressure of 100-2600 tons.

16. The PVC composite flooring according to claim 3, wherein the decorative board with alumina hot-pressed on the surface was prepared by the following process: alumina was hot-pressed on the surface of the decorative board at 170-230° C. and a pressure of 100-2600 tons.

17. The PVC composite flooring according to claim 4, wherein the decorative board with alumina hot-pressed on the surface was prepared by the following process: alumina was hot-pressed on the surface of the decorative board at 170-230° C. and a pressure of 100-2600 tons.

18. The PVC composite flooring according to claim 5, wherein the decorative board with alumina hot-pressed on the surface was prepared by the following process: alumina was hot-pressed on the surface of the decorative board at 170-230° C. and a pressure of 100-2600 tons.

19. The PVC composite flooring according to claim 6, wherein the decorative board with alumina hot-pressed on the surface was prepared by the following process: alumina was hot-pressed on the surface of the decorative board at 170-230° C. and a pressure of 100-2600 tons.

20. The PVC composite flooring according to claim 2, wherein the number of revolutions in the abrasion resistance test according to EN 660-2:1999+A1:2003 AND EN 649:2011 was at least 6000 revolutions.
